(19) United States
(12) Patent Application Publication
(10) Pub. No.: US 2014/0145704 A1
(43) Pub. Date: May 29, 2014

(54) Method for Localizing Objects Enclosed in a Medium, and Measuring Device for Carrying Out the Method

(71) Applicants: Reiner Krapf, Filderstadt (DE); Tobias Zibold, Stuttgart (DE); Andrej Albrecht, Stuttgart (DE)

(72) Inventors: Reiner Krapf, Filderstadt (DE); Tobias Zibold, Stuttgart (DE); Andrej Albrecht, Stuttgart (DE)

(73) Assignee: Robert Bosch GmbH, Stuttgart (DE)

(21) Appl. No.: 13/819,048

(22) PCT Filed: Jul. 28, 2011
(86) PCT No.: PCT/EP2011/063051

§ 371 Date: May 8, 2013

(30) Foreign Application Priority Data
Aug. 30, 2010 (DE) 10 2010 039 953.1

(51) Int. Cl. G01V 3/10

(52) U.S. Cl. CPC G01V 3/10
USPC 324/67

(57) ABSTRACT

The disclosure relates to a method for localizing objects enclosed in a medium in which a measurement signal correlated to the enclosed object is generated and is used to produce a signal for transmission to a user. The signal allows at least a distinction between a first state “Object detected” and at least one second state “no object detected.” The disclosure proposes that a third state “Object close by” be provided. Furthermore, the disclosure relates to a measuring device, particularly a hand-held locating device, for carrying out the method according to the disclosure.

The invention relates to a method for localizing objects enclosed in a medium as claimed in the preamble of claim 1 and to a measuring device, especially a hand-held positioning device, for carrying out the method as claimed in claim 14.

### PRIOR ART

Positioning devices have been used for some time for detecting objects such as, for example, electric lines, water lines, pipes, metal stands and also wooden beams, enclosed in a medium such as, for example, a wall, a ceiling or a floor. In this context, inductive devices, among others, are used, i.e. devices which generate a magnetic field which is disturbed by the metallic objects enclosed in a medium. Apart from these inductive devices, capacitive devices, mains voltage detectors and radio-frequency detectors are also used. In the case of mains voltage detectors or also AC detectors, only a receive wire loop system is used in order to detect the desired signal and thus to localize a corresponding object.

The indication whether a sensor detects an object is mostly implemented by LEDs, segmented LCDs and/or graphic displays. In the case of measuring systems of this type, a display is typically used which reproduces the variation of the signal strength of the sensor. That is to say the sensor signal obtained is displayed to the user as an output signal, for example in the form of a bar display or a row of LEDs. The user can thus detect the position of an object by looking with the device for the position having the maximum amplitude of the row of LEDs/bar display.

There are also simpler devices having only one LED which have a fixed threshold for the signal strength. The LED is switched on at the device when the sensor signal exceeds a particular preset value. In this context, there are also devices which do not use a fixed threshold but a threshold which can be changed by the user, i.e. the user adjusts the “sensitivity” at a control knob, this being the threshold of the sensor signal at which the warning lamp/LED of the device lights up.

Furthermore, there are devices (e.g. “DMF 10 Zoom” by Bosch) which do not, or not only, inform the user about the presence of enclosed objects via an LCD display or row of LEDs or a single LED, but via an LED which changes its color. Thus, the “DMF 10 Zoom” mentioned above varies the color of an output unit from green to red as soon as an object has been found. Such a system is known from DE 10 2004 011 285 A1.

Apart from by means of a fixed signal threshold at which an LED of an output unit is activated, i.e. a change in color occurs as in DE 10 2004 011 285 A1, a flowing (adaptive) threshold can also be used which only activates the display and/or LED in the range of the signal peak of the sensor signal which increases the “selectivity” of the object localization. Such a system is known, for example, from DE 10 2005 015325 A1.

### DISCLOSURE OF THE INVENTION

In the method according to the invention for localizing objects enclosed in a medium, a measurement signal is generated which enables information to be obtained about the position of the enclosed object. This signal is, for example, a voltage induced in a receive wire loop system of a sensor of a measuring device operating in accordance with the method according to the invention. In this arrangement, an enclosed object can be detected and also localized via the relative signal strength.

From the measurement signal thus obtained which contains information about the position of the enclosed object, an output signal Z (state signal) is generated which enables a user of the method according to the invention or of a measuring device operating in accordance with this method to distinguish between at least three states of detection in the localization. Thus, the method according to the invention generates a first signal Z=a which corresponds to the state “object detected”. A second state “no object detected” can be distinguished via a second signal Z=b which is also generated from the measurement signal.

In the method according to the invention, a third state Z=c containing the information “object in the vicinity” is also advantageously generated. Advantageously, three “warning stages” thus exist in the device which reflect the level of danger of the measurement situation. In particular, these are discrete warning stages and precisely three warning stages which are in each case associated with an unambiguous meaning. This must not be mistaken for a measurement signal which only rises and which signals to a user that the measuring device is moving towards an object that thus must thus be somewhere close in the vicinity. In the method according to the invention, there are three concrete discrete states between which switching is effected.

When using a system having an adaptive threshold as has been mentioned above in conjunction with DE 10 2005 015325 A1, a disadvantage, which is not to be underestimated, of a direct change from the state “no object detected” to the state “object detected” is the fact that the output unit, for example an LED, can indicate “green” (“no object detected”) in such devices even though the user is located above an object, if this object is smaller than an adjacent larger object, since the dynamic threshold for the change of state is determined from the large object. The user could misunderstand the “green” display (“no object detected”) and drill into a hidden object, for example a water line.

The disadvantage of a direct change from the state “no object detected” to the state “object detected” in a method having a fixed preset threshold is the fact that the device warns against an object over a very large area and a precise localization of the enclosed object is scarcely possible (similar to what is observed frequently, for example, in the case of “low-cost devices”).

The additional state Z=c (“object in the vicinity”) advantageously enables the detection threshold, below which the state information “no object detected” is output, to be selected to be very low without there being produced, on the other hand, in the case of strong signals, a distinct and no longer justifiable overdriving in the case of which accurate localization of an individual object would no longer be possible.

The method according to the invention or a measuring device operating in accordance with this method conveys to a user advantageously whether he is not above an object or in the vicinity of an object or directly above an object. In the latter two cases, it is clearly signaled to the user that drilling is or could be dangerous here. Advantageously, at least three “warning stages” are present in the device which reflect the level of danger of the measurement situation. In a particularly advantageous embodiment, precisely three warning stages are provided which are connected with a clear, unambiguous item of information for a user.

By means of the three state or warning stages according to the invention, a user is reliably warned when it could be dangerous and he is informed about the precise position of the object especially by a state information item.

A further advantage of the at least three state or warning stages is that a measuring device operating in accordance with the method according to the invention indicates to a user clearly how the user should behave:
State Z=b: “No object detected”: e.g. green LED display:
   Drilling non-critical and allowed.
State Z=c: “Object in the vicinity”: e.g. amber LED display:
   Caution advisable. Drilling allowed only when other information sources such as, for example, construction plans or other measuring devices can also be used.
State Z=a: “Object detected”: e.g. red LED display:
   Object directly under the device. Identification of the center of the object. Thus, precise localization of the object is possible.

By means of the features listed in the dependent claims, advantageous developments of the localizing method according to the invention are possible.

In the method according to the invention, the system changes advantageously from the first state “object detected” to the third state “object in the vicinity” if the size of the currently measured measurement signal is below a threshold value Uu. This threshold value can be advantageously defined dynamically. Thus, in the method according to the invention, it is possible to change from the first state “object detected” to the third state “object in the vicinity” if the size of the currently measured measurement signal is below the value of a previously measured local maximum value of the measurement signal by a predetermined first percentage.

Devices of the prior art typically convey the information that an object has been detected if the measurement signal exceeds a predetermined measurement signal threshold for object detection. Such a fixed measurement signal threshold has the consequence that in the case where the measurement signal of an object is below this threshold, no object can be detected. If, however, it is an object having a very large measurement signal in which this fixed measurement signal threshold is exceeded already very early, that is to say, for example, at a great distance from the object to be localized, an object can be detected but not localized particularly accurately.

The method according to the invention now limits the state (Z=a) “object detected”, which informs a user that an object has been localized, to a relative signal strength with respect to a measurement signal peak previously measured during the same measuring process. If a measurement signal peak is detected which is typically associated with the localization of an enclosed object, the range of distance allocated to the localized, i.e. detected, enclosed object is limited due to the fact that the measured measurement signal is below a defined percentage of the previously measured measurement signal peak.

In this manner, it is possible, for example, to differentiate between objects arranged closely together which, with a constant measurement signal threshold, would lead to a signal which would lie above the measurement signal threshold over the entire area of the two enclosed objects.

The method according to the invention therefore ensures advantageously also an accurate localization of objects enclosed in a medium.

On the other hand, the method according to the invention changes from the third state “object in the vicinity” (Z=c) to the second state “no object detected” (Z=b) only if the size of the measurement signal currently measured is below a predeterminable first threshold value. This first threshold value can be, for example, the signal noise level of the detection system. The method according to the invention for localizing objects has in the present embodiment preferably a relatively low first threshold value. It is only above this threshold value that an object can be detected at all as such and thus localized.

In this manner, a user can be sure that in the case of the Z=b “no object detected” state, there is really no object present at the location of the measuring point. Wrong measurements of dynamic systems as have been described above can thus be avoided almost completely.

In the opposite case, the method according to the invention changes from the second state “no object detected” (Z=b) to the third state “object in the vicinity” (Z=c) if the size of the currently measured measurement signal exceeds a predeterminable first threshold value, for example the threshold value of the noise level (U_{SR}) of the detection system.

The method according to the invention changes from the third state “object in the vicinity” (Z=c) to the first state (Z=a) “object detected” if the size of the currently measured measurement signal (U_{M}) exceeds a predeterminable second threshold value (U_{U}). The predeterminable second threshold value (U_{U}) can correspond advantageously to a previously measured local minimum value (U_{Min,n}) of the measurement signal increased by a predeterminable second percentage P₂.

A state Z (Z=a, Z=b, Z=c) can be conveyed advantageously to a user by means of a color code, especially by means of different colors. Thus, the respective detection state Z (Z=a, Z=b, Z=c) can be conveyed to a user especially by means of three different colors. Thus, it is advantageous, for example, to allocate an amber hue to the “object in the vicinity” (Z=c) state.

If the exactly three warning stages are designed analogously to a traffic light (red (Z=a); amber (Z=c); green (Z=b)), such a transmission/indication of state can also be understood intuitively and is self-explanatory worldwide. In this context, the three colors can be implemented separately (one discrete LED per color) or by a single visual display which changes its color (dual- or multi-color LEDs) or by a diffuser which mixes the light of the LEDs and thus generates the colors (e.g. red and green LEDs, when operated simultaneously behind a diffuser, generate the mixed color amber). This could be implemented especially cost-effectively.

Naturally, the transmission of the detected state Z to a user does not need to be effected (purely) visually but can also take place, for example, by means of an audible warning via a loudspeaker or, for example, also a so-called “beeper” in accordance with the same principle, for example with a rising sequence of tones.

Instead of colors or tones, a voice output can also be used for wirelessly transmitting the state to a user.

Further options for transmitting the states in the method according to the invention will be discussed further in conjunction with the measuring device operating in accordance with the method in the text which follows.

By means of the method according to the invention which provides for a more accurate localization of enclosed objects, a user can perform a very accurate localization of enclosed objects merely via the change in state “object detected” or “no object detected” without having to know the accurate variation of the measurement signal. In addition, the user is unambiguously signaled in which situations he can drill without danger, for example into a wall, since there is no enclosed object present at this point.

In normal positioning devices having only two warning stages, namely “no object detected”/“object detected”, the warning that an object is detected must take place very early so that the sensitivity of the device and thus the maximum depth of search does not cut back. The consequence is a warning by LED or beeper over a large area without being able to deduce clear information about where the object is located exactly.

A measuring device operating in accordance with the method according to the invention now no longer indicates the “object detected” state over a wide area of movement. In particular, the measuring area assigned to the localized object is restricted more and more, for example due to the dynamic thresholds when the direction of movement of the measuring instrument is changed several times. By means of the precisely three warning stages existing, the user is reliably warned when it could be dangerous and he is now informed really about the precise position of the object by the first warning stage.

For this purpose, the measuring device according to the invention has output means which allow the state (Z) measured in each case to be reproduced. The state Z (Z=a, Z=b, Z=c) is advantageously reproduced visually, especially by means of three different colors. For example, the different states could be color coded differently. It is also possible to distinguish the different states by a different repetition rate of a visual signal.

If the three warning stages are designed analogously to a traffic light (red (Z=a); amber (Z=c); green (Z=b)), such a transmission/display of state is also understandable and self-explanatory intuitively worldwide.

Naturally, the colors can be selected arbitrarily, green-amber-red naturally being advantageous.

In addition, exactly three warning stages or state indicators Z provide unambiguous information about the basic hazard potential.

For this purpose, the measuring device can have one or more LEDs or be provided with one display as output means.

The colors for transmitting the detection state can be generated, for example, also by the backlight of a segment or graphics display or by an OLED display.

The display (LED array) can be of such a size that it can represent the actual dimensions of the object. In the case of an LED array, the LEDs are then, for example, red above an object, for example amber above uncertain locations and, for example, green in the case of a certain absence of an object.

In the case of a measuring device which is constructed as stud sensor, a modification can also be performed such that, for example, red is indicated above an object, amber for example at the edges of a beam/stud and, for example, green next to the object.

It is especially in the case of devices for detecting beams in lightweight walls that the third warning stage can also be activated if the device is on the right of the left-hand edge of the beam and on the left of the right-hand edge of the beam. This requires an edge detection function but this already exists in the devices for detecting beams according to the prior art. In devices for detecting beams based on low-frequency capacitive sensors, too, the detection of beam edges is possible, e.g. by means of differential measuring electrodes. In this context, local extremes are obtained in the measurement signal at the position of the beam edges. Similarly, such differential measuring electrodes provide for the accurate and unambiguous determination of centers by means of a zero transition in the measurement signal. According to the invention, it is thus also possible that the first warning stage “object detected” is activated only within a very small area around the center of the beam and a further transition stage is activated (for example periodically alternately coded as amber/red) in the area to the left of the center and to the right of the left-hand edge or, respectively, to the right of the center and to the left of the right-hand edge, that is to say over the width of the beam.

A so-called bar chart or a bar scale (or the like) on the display of a measuring device could also be displayed in different colors so that the indication in the display would be combined additionally directly with the color information of the detection state Z.

As a “first color” in the color coding of the three states according to the invention, for example for transmitting the Z=b (“no object detected”) state, an LED which is switched off could also be used, in particular, so that the Z=b, Z=c, Z=b states would correspond to the “off”; “amber”; “red” types of the illumination.

The meaning of the colors/displays/signals of the three warning stages could be explained on the housing of the measuring device, for example also on a sticker as traffic signal symbol or in the online operating instructions in the display of the device.

In other exemplary embodiments, the size of the area of light could also be varied or the brightness could be modulated, for example in three stages.

It would be possible to use LEDs, lamps, other means of lighting, an illuminated hole as in the DMF 10 Zoom device (compare also DE 10 2004 011285 A1), an illuminated housing (e.g. of acrylic), an illumination of the wall or projection of a symbol onto the wall (e.g. line, crosshairs, etc.), laser for representing and transmitting the warning stages/the Z state.

In alternative exemplary embodiments, intermittent light signals (red flashing, red-green alternating flashing, fast or slow flashing) could also be used instead of different colors.

Apart from a visual reproduction of the states, an audible reproduction, for example a state differing in pitch or a different repetition rate of one and the same tone is naturally also possible.

Instead of colors or tones, a voice output could also be used.

As an alternative, a vibration of the device (none-weak-strong) analogous to the vibration alarm of mobile telephones could also be used.

Further more advantageously, the measurement signal is measured as a function of a lateral displacement of a sensor. In this context, one or more sensors are implemented on the positioning device which can detect the presence of metals (inductive sensors), wooden beams (capacitive sensors), voltage-conducting cables (50 Hz sensors) and/or arbitrary objects (radar, UWB, radio-frequency sensors). Such a sensor can have, for example, one or more transmit coils and one receive wire system. In alternative embodiments, such a sensor can have, for example, only one receive wire loop system in order to enable alternating currents to be localized, for example. A capacitive sensor, for example for looking for wooden beams, is also possible. Alternative embodiments of a measuring device can comprise a sensor having an antenna element for sending out and/or detecting RF signals, especially UWB (ultra wideband) signals. An “ultra wideband signal” is intended to be understood, in particular, as a signal which has a frequency spectrum having a center frequency and a frequency bandwidth of at least 500 MHz. The center frequency is preferably selected in the frequency range from 1 GHz to 15 GHz.

The sensors can be integrated in each case individually in a measuring device or also combined to form a number of arbitrary combinations in a single measuring device. In this context, for example, such a measuring device constructed in accordance with the method according to the invention can be displaced or moved over a wall so that corresponding objects such as, for example, metal parts, power cables or also wooden beams which are enclosed in this wall can be localized. In this context, a particular magnitude of a measurement signal is assigned to each position of the measuring device which is then measured, for example, via path sensors of the device.

Such a measuring device for carrying out the method according to the invention which, in particular, can be constructed as a hand-held positioning device, advantageously has output means which allow the “object detected”, “object in the vicinity” or “no object detected” state measured in each case to be reproduced. In this context, a separate output unit can be provided for each sensor present, or the state signals of all sensors combined in the measuring device are output via a central output unit of the measuring device, for example a graphical display. An audible output is also possible. By means of the reproduction of the respective state (“object detected”, “object in the vicinity” or “no object detected”) of individual sensors, a user can thus be informed whether the measuring device is located within the area of a localized object and what type of object this could be.

The measuring device according to the invention has at least one sensor which has at least one receive wire loop system, for example a receive coil. Further transmit or receive coils or also further sensors, respectively, are similarly possible in other embodiments of the measuring device according to the invention. In this context, such a sensor is calibrated in such a manner that in the case of a localization of an object, a signal change in the case of a movement of the device relative to the object becomes measurable. By means of the method according to the invention or, respectively, by means of a measuring device carrying out the method according to the invention, for example a hand-held positioning device, increased accuracy is possible in the localization of the object enclosed in a medium. In spite of the very high dynamic range of the measurement signal generated by the sensor, an improved accurate localization of the object is possible due to the dynamic correlation of states in accordance with the method according to the invention. The first state Z=a, i.e. “object detected” thus just corresponds to the transmission of information “object localized”. Accurate position finding, i.e. localization of an enclosed object thus becomes possible advantageously.

Further advantages of the method according to the invention or of a measuring device for carrying out this method, respectively, can be found in the subsequent description of an exemplary embodiment and the associated drawings.

### DRAWING

The drawing shows an exemplary embodiment of the method according to the invention which shall be explained in greater detail in the description following. The figures of the drawing, their description and the claims contain numerous features in combination. An expert will consider these features also individually and combine them to form other or further meaningful combinations.

In the figures:

FIG. 1 shows a typical measuring situation for positioning and localizing an object enclosed in a medium in a diagrammatic representation.

FIG. 2a shows a diagrammatic representation of the variation of the detected measurement signal and of the reproduced state as a function of the location when using a method according to the prior art.

FIG. 2b shows the measurement situation of a diagrammatic representation forming the basis of the variation of the measurement signal from FIG. 2a.

FIG. 3a shows a diagrammatic representation of the variation of the detected measurement signal and of the reproduced state as a function of the location when using the method according to the invention.

FIG. 3b shows the measuring situation forming the basis of the variation of the measurement signal from FIG. 3a in a diagrammatic representation.

FIG. 4 shows a detailed representation of the variation of the measurement signal and the resultant state signal in the immediate vicinity of an object to be localized in a diagrammatic representation for illustrating the function of the “dynamic threshold” usable in the method.

FIG. 5 shows a perspective view of a possible exemplary embodiment of a measuring device according to the invention.

### DESCRIPTION OF AN EXEMPLARY EMBODIMENT

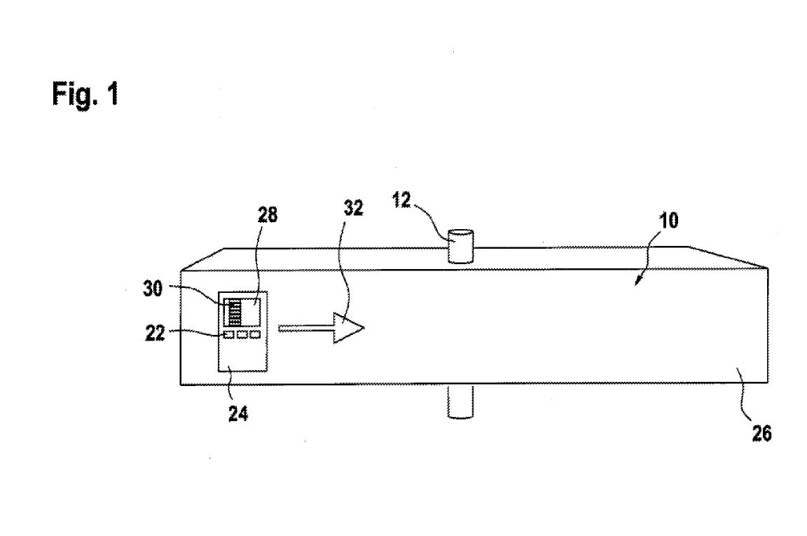

FIG. 1 shows a typical measuring situation for positioning objects enclosed in a medium 10, for example a wall, a floor or a ceiling. A positioning device 24 is displaced over the surface 26 of a medium 10 to be examined in order to detect, i.e. localize, the position of an object 12 enclosed in the medium 10. Such an object 12 can be, for example, an electrical line, pipes or water pipes, metal stands or also other objects such as, for example, wooden beams. The positioning device can be an inductive positioning device, a capacitive positioning device, a radar positioning device or also a combination of these detection methods. However, the method according to the invention is not restricted to these detection methods. Such a positioning device 24 can have, in particular, an inductive sensor having at least one transmit coil and a receive wire loop system serving as receive unit. However, such a measuring device can also be a mains voltage detector which only has a receive wire loop system, for example a coil, as sensor for detecting the measurement signal.

If a corresponding object is then located in the vicinity of the receive geometry, this object modifies, for example, the field generated by the transmit geometry so that a resultant flux is induced in the receiver, for example in the receive coil. The flux induced in the receive coil or a receive wire loop system, respectively, can then be picked up as measurement voltage, for example at the coil or a down-stream measurement amplifier. The closer the inductive sensor comes to the enclosed object, the greater the detected measurement signal, for example the measurement voltage U_{M} picked up.

Apart from corresponding drive electronics, the associated power supply and an evaluating unit for the detected measurement signal, such a positioning device 24 has, for example, also a graphical display 28 which reproduces an output variable which is correlated with the intensity of the detected measurement signal. The output variable can be represented, for example, in the form of a bar chart 30, the number of illuminated bars between a minimum value and a maximum value representing a measure of the intensity of the measurement signal. Apart from the representation of the output variable shown in FIG. 1, by means of a bar chart 30, other output forms, especially other visual representations are also possible. Thus, the “object detected”, “object in the vicinity” or “no object detected” state can be displayed, for example, via corresponding light-emitting elements 22.

If such a positioning device 24 approaches an enclosed object 12 as would be the case, for example, by displacing the device in the direction of the arrow 32 according to the representation in FIG. 1, the detected measurement signal increases.

It is particularly in devices of the prior art that measuring situations may occur in the vicinity of the enclosed object 12 in which the measurement signal is so strong over a relatively long traveling distance of the positioning device 24 in the area of the object 12 to be detected that the maximum amplitude of the output variable, for example of the measurement voltage U_{M} picked up, is reproduced over the entire range. In this case, precise positioning, i.e. localization of the position of the enclosed object 12 is not possible.

When using a system having a so-called adaptive threshold as has already been described above, on the other hand, the output unit, for example an LED, can indicate “green” (“no object detected”) even though one is located above an object. This happens especially when this object is smaller than an adjacent, larger object since the threshold for the change in state is then determined by the large object. The user could misunderstand the “green” state indication (“no object detected”) and drill into a hidden object, for example a water line. Thus, there exists a disadvantage of a direct change from the “no object detected” state to the “no object detected” state which is not to be underestimated.

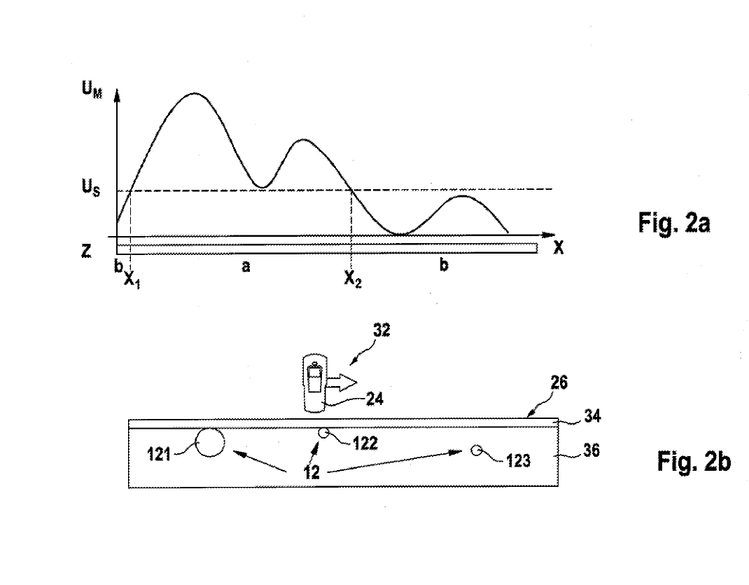

FIG. 2a shows the variation of the measurement signal U_{M} and the possible reproduction of the states Z “object detected” “object in the vicinity” and “no object detected”, respectively, in a localizing method having a fixed threshold according to the prior art. In this context, the “object detected” state corresponds to the area Z=a and the “no object detected” state is marked by Z=b in FIG. 2a.

The basic measuring situation is reproduced in FIG. 2b. Various objects 12, for example water lines, power lines or the like, are enclosed in a medium 36. The position of these enclosed objects 12 is to be localized by means of a positioning device 24. For this purpose, the positioning device 24 is moved in the direction of the arrow 32 over the surface 26, for example a wall 34. FIG. 2a shows the associated signal variation of the measurement signal U_{M} which can be, for example, the voltage induced in a coil of the measuring device, as a function of the lateral displacement X of the measuring device 24 over the surface 26 of the wall to be examined.

If the measuring device with its sensor is still far away from an enclosed object 12, the corresponding measurement signal is still low. Measuring devices of the prior art mostly have a detection threshold U_{S}. If the measurement signal of an object is below this threshold U_{S}, the object is not detected as such and can thus not be localized. In this case, a measuring device outputs an item of information which reflects the state “no object detected” (Z=b). Such a “no object detected” state is assumed in areas b of the lateral path of movement X in the measurement situation shown in FIG. 2. If one approaches an object 12 enclosed in the medium 36 with a measuring device 24, especially the object 122, the measurement signal U_{M} increases. If the measurement signal U_{M} currently measured exceeds the measurement signal threshold U_{S}, the state Z changes from “no object detected” (Z=b) to the “object detected” state (Z=a). This informs a user that the measuring device has found an enclosed object.

In the method of the prior art according to FIG. 2, the “object detected” state (Z=a) is indicated over a wide lateral traveling distance X of the measuring device 24 since the signal value U_{M} currently measured in each case is above the detection threshold U_{S} in this entire area. In particular, it is not possible by means of the method shown in FIG. 2 to detect that there are two separate enclosed objects 121 and 122 which contribute to the measurement signal U_{M} being above the detection threshold U_{S} over a wide area. Accurate localization of the objects 121 and 122, respectively, is not possible with such a method which only transmits the changes in state.

In addition, it is also not possible by means of such a method to localize an object 123 which generates a measurement signal U_{M} which is below the measurement signal threshold for object detection. If the measurement signal U_{M} currently measured is below the measurement signal threshold U_{S} as is shown in the lateral position X₂ in FIG. 2a, the “object detected” state (Z=a) changes to the “no object detected” state (Z=b). Since the measurement signal U_{M} currently measured stays below the measurement signal threshold U_{S} also in a further method of the measuring device 34, the second “no object detected” state is maintained over the entire area b even though the object 123 produces a distinct signal deflection of the measurement signal U_{M}.

The method of the prior art, shown in FIG. 2, thus has the disadvantage that an object which generates a measurement signal which is below the measurement signal threshold cannot be detected at all as an object. If the threshold value level is lowered in order to localize also a relatively small object such as, for example, object 123, the effect of overdriving and nondifferentiability of high-signal objects such as objects 121 and 122 is increased. This is because, if this is an object with a very large measurement signal in the case of which the measurement signal threshold is exceeded already early, that is to say at a very great distance from the object to be localized, the object can indeed be detected but accurate localization or also differentiation between different objects is not possible.

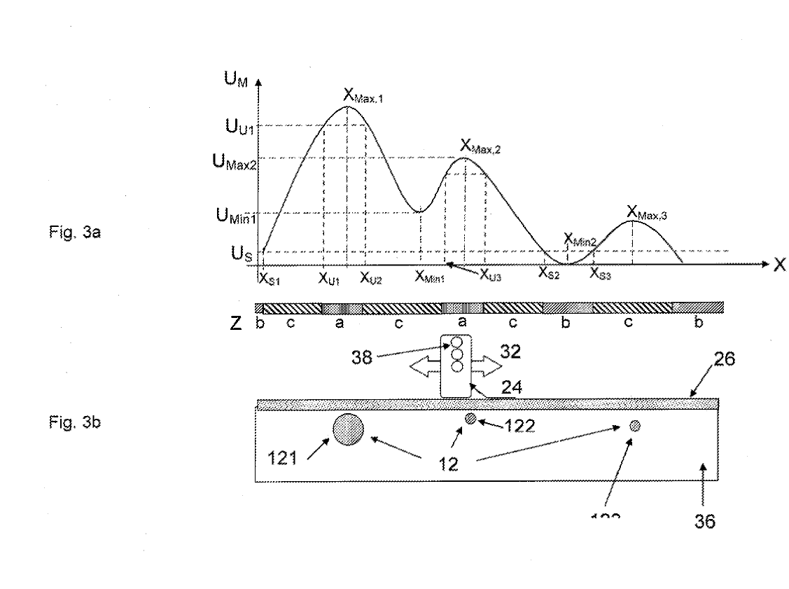

FIGS. 3a and 3b show a corresponding measuring situation when using the method according to the invention. The measuring situation in FIG. 3b corresponds to the measuring situation of FIG. 2b. A measuring device 24 which operates in accordance with the method according to the invention is displaced in the direction of arrow 32 over the surface 26 of a wall, a floor or a ceiling. Objects 12 which, for example, could be water pipes, power lines or also wooden beams, are enclosed in the medium 36.

FIG. 3a shows, on the one hand, the variation of the measurement signal U_{M} detected by the measuring device, and a state signal (Z) which is generated from the measurement signal U_{M} and which distinguishes between the three discrete states of “object detected” (state Z=a), “object in the vicinity” (state Z=c) and “no object detected” (state Z=b). In particular, the method according to the invention has exactly three states Z.

The method according to the invention for detecting and localizing objects has a relatively low fixed threshold U_{S}. It is only above this threshold U_{S} that an object can be detected as such at all. The threshold used can be in this case, for example, the noise threshold of the detection system. If the measuring device operating in accordance with the method according to the invention is displaced in the direction of the arrow 32 over the surface 26, the measurement signal U_{M} currently measured increases as shown in FIG. 3a. If the measurement signal U_{M} currently measured exceeds the predetermined measurement signal threshold U_{S}, a signal is generated which represents the state Z=c (“object in the vicinity”). At position X_{S1}, the state display changes from Z=b (“no object detected”) to state Z=c (“object in the vicinity”). The Z=b signal tells a user advantageously that no object has been localized and there can be no object in the vicinity, either. At this point, risk-free working is possible, for example. The signal Z=c tells a user that, although an object has not yet been localized definitively, an object could be or should be in the vicinity. Thus, caution would be advisable at such a point X. For example, other information such as electrical or sanitary layout or construction drawings or the like should be utilized for ensuring, for example, that there is really no object present at the current measurement position X. The additional state of Z=c (“object in the vicinity”) advantageously enables the detection threshold U_{S} to be selected to be very low without resulting in a distinct and no longer justifiable overdriving in the case of strong signals.

To reproduce the Z=a state or the contrary Z=b state and the Z=c state, it is possible, for example, to use the color signal of three different light-emitting diodes 38 which are integrated in the measuring device 24 as output means. If the Z state changes from “no object detected” (Z=b) to an “object in the vicinity” state (corresponding to Z=c), it is possible to switch, for example, from a green light-emitting diode to an amber light-emitting diode in order to signal to a user that he should now proceed with increased caution since there could be or will be an object in the vicinity of the measuring position.

In the case of further displacement of the measuring device 24 in the direction of arrow 32 in FIG. 3b, the measurement signal U_{M} increases further and the state transmitted to a user initially remains set to Z=c. The increase in the measurement signal can be transmitted to a user, for example by means of an additional bar display. At a position X_{U1}, the switchover point from state Z=c (“object in the vicinity”) to the state Z=a (“object detected”) is reached. The threshold U_{U} for switching the state display from state Z=c (“object in the vicinity”) to the state Z=a (“object detected”) can be a static threshold or also designed as dynamic threshold, as described in DE 102005015325 A1. To describe the operation, a static threshold is temporarily assumed at this point. The operation of a corresponding dynamic threshold which requires the transgression of the maximum value will be described further below.

At a position X_{Max1}, a first maximum value U_{Max1} is reached for the measurement signal U_{M}. The increase in the measurement signal up to there can be transmitted to a user, for example by means of an additional bar display, should this be desired.

If, in the method according to the invention, the current measurement signal U_{M} drops back to the switchover threshold U_{U}, for example due to further displacement of the measuring device in the direction of arrow 32, that of the state displays changes from the Z=a output (“object detected”) to the Z=c state (“object in the vicinity”). The output of the measuring device thus signals to a user that he has left the precise area of localization of the object found again but that it can still be expected that the object is still “in the vicinity”.

The threshold for the transition from Z=a (“object detected”) to the Z=c state (“object in the vicinity”) can advantageously also be a dynamic threshold. This will be described briefly in the text which follows, additionally referring to DE 10 2005 015325 A1 which should thus also be considered as content of disclosure of the present application.

If, in the method according to the invention having a dynamic threshold, the current measurement signal U_{M} drops, for example due to further displacement of the measuring device in the direction of arrow 32 by a predetermined percentage P₁ compared with the maximum value U_{Max1} measured last, back to a value U_{U1}, the signal Z which characterizes the respective state of the system changes from the Z=a state (“object detected”) to the Z=c state (“object in the vicinity”).

It is thus possible to change, for example, from the Z=a state to the Z=c state if the currently measured measurement signal U_{M} has dropped by 15% compared with the maximum value U_{Max1} previously measured (i.e. U_{U1}=U_{Max1}*(1−0.15)). In this context, the value of 15% is only a typical value, for example a possible value which should not signal any restriction. Other values are also possible. It is especially possible to optimize this switchover threshold between the Z=a state and the Z=c state in the case of different detection programs for a measuring device to the different response characteristic of enclosed objects due to their material composition. Depending on the sensor principle used (for example inductive sensor, capacitive sensor, AC sensor), this first percentage P₁ can also be optimized. It should be noted that this first percentage P₁, like a second percentage P₂ still to be described, does not represent an absolute value but is based on the respective previously measured amount of the maximum value U_{Max,n} or, in the case of the percentage P₂, on a minimum value Uₘᵢₙ of the measurement signal U_{Min,m}. The respective change in signal in the measurement signal U_{M}, which is necessary for switching from a Z=a state to a Z=c state or conversely, is thus not absolute but can thus be called dynamic dependent on the magnitude of the existing measurement signal. In addition, this threshold moves due to the different percentages P₁ and P₂, respectively, of the threshold value definition with each passing of a maximum or minimum of the measurement value U. The result is that even relatively small measurement signals which are generated, for example, by relatively small objects such as, for example, an object 122 or result from an object enclosed deeper in the medium such as, for example, an object 123 are adequately delimited compared with a strong signal such as is generated, for example, by an object 121, so that accurate localization of these individual objects is individually possible.

If the measuring device 24 is moved further in the direction of arrow 32 of FIG. 3b beyond the object 121, the measurement signal U_{M} drops further and reaches a minimum value U_{Min1} at a point X_{Min1}. If the measuring device is moved further beyond this point in the direction of arrow 32, the measurement signal rises again due to the effect of the enclosed object 122. The measuring device would indicate the Z=c state (“object in the vicinity”) over the entire traveling distance from X_{U2} to X_{Max2} if the static switchover threshold U_{U1} were provided for switching from the Z=c state to the Z=a state. Even when a lateral position X_{Max2} corresponding to a second local maximum value U_{Max2} is reached, the state display would be at Z=c, although the position X_{Max2} can be identified with the precise position of an enclosed object 122. In the method according to the invention, compared with methods of the prior art, however, this would only be a slight disadvantage and especially also one which is justifiable for safety reasons since a user is prewarned by the state display Z=c (“object in the vicinity”) that there must be an object in the vicinity and, for example, could also determine the accurate position of the object via an additional bar display. Advantageously, however, this would not be a hazardous misinformation as is described with a conventional measuring system in the case of the object 123 in FIGS. 2a and 2b, due to the method according to the invention.

In an advantageous embodiment with a dynamic threshold, the measuring device would again switch from the Z=c state (“object in the vicinity”) to a Z=a state (“object detected”) already at the position X_{U3}. This dynamic threshold for the transition from the Z=c state (“object in the vicinity”) to a Z=a state (“object detected”) can be implemented, for example, as follows.

If the measurement signal U_{M} currently measured rises, starting from a previously detected minimum value, for example U_{Min1}, by a predetermined second percentage P₂, the method according to the invention switches the Z state of the signal from Z=c (“object in the vicinity”) to a Z=a state (“object detected”). The second percentage P₂ could be, for example, 10%, especially if the first percentage is 15%, these 10% again only being intended to reproduce a typical value and do not represent any restriction on possible values.

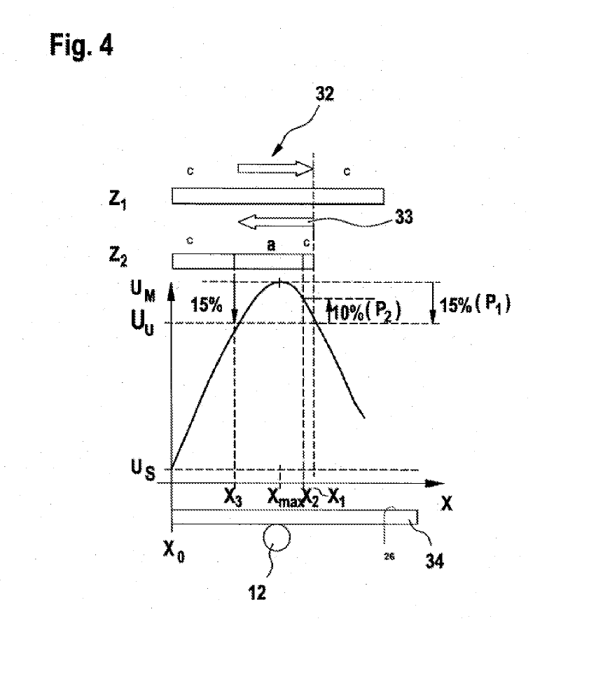

Advantageously, however, the second percentage P₂ should be selected to be smaller than the first percentage P₁ as will still be discussed in conjunction with FIG. 4.

If the measuring device is moved beyond the X_{Max2} position, the measurement signal U_{M} drops again with increasing distance from the enclosed object 122. If the measurement signal U_{M} currently measured drops by the percentage P₁ (for example 15% in FIG. 3a) below the value of the previously measured maximum U_{Max2} of the measurement signal, the state signal Z switches again from condition Z=a to the state Z=c. This signals to a user that he has left the precise localization area of a detected object 122 again, but the object is still in the vicinity. In particular, this information “object in the vicinity” is generated when the measurement signal U_{M} is above the measurement signal threshold U_{S}. This enables enclosed objects to be localized more accurately than would be possible when using only a constant measurement signal threshold.

If the measuring device 24 according to the invention is moved further in the direction of arrow 32, the measurement signal U_{M} currently measured becomes smaller than the measurement signal threshold U_{S} at a position X_{S2} which leads to a change in the Z=c state to the Z=b state (“no object detected”).

In the case of a further displacement of the measuring device 24 in the direction of arrow 32 beyond the position X_{S2}, the measurement signal U_{M} passes through a further local minimum U_{Min2} at position X_{Min2} and subsequently rises again due to the influence of a further object 123 becoming noticeable (see FIG. 3b). With this increase in the measurement signal U_{M}, the state is switched from Z=b to the Z=c state (“object in the vicinity”) if the measurement signal U_{M} currently measured exceeds the threshold value U_{S} or exceeds a predetermined percentage of the signal value U_{Min2} of the minimum.

In an advantageous embodiment, the method according to the invention changes from a Z=b state (“no object detected”) to a Z=c state (“object in the vicinity”) if the minimum value of the measurement signal measured last is exceeded by a defined percentage P₂ or the magnitude of the measurement signal U_{M} currently measured rises above a fixed threshold value U_{S}, if this is greater. Since the threshold value U_{S} is greater than the 10% rise P₂ of the U_{Min2} value of the minimum of the measurement signal last measured (this shall be assumed for illustrating the principle) in the exemplary embodiment of FIG. 3a, the state is switched from Z=b to Z=c when the threshold value U_{S} is exceeded.

With a further displacement of the measuring device 24 in the direction of arrow 32, the measurement signal U_{M} currently measured rises due to the approach to the enclosed object 123 and reaches a further local peak, the position of which can be identified with the position of the enclosed object 123, at the position X_{Max3}. If the measuring device is moved beyond this position X_{Max3} in the direction of arrow 32, the measurement signal U_{M} currently measured drops again due to the increasing distance from the signal-generating enclosed object 123. If the measurement signal U_{M} currently measured drops by a fixed percentage P₁, by 15% in the exemplary embodiment of FIG. 3a, compared with the value of the maximum value U_{Max3} of the measurement signal last measured, the Z=c state would be changed to the Z=b state due to the intensity U_{U3} of the measurement signal then present. In the present case, however, the signal level of the fixed threshold value U_{S} is previously reached again already so that on dropping below this signal level U_{S} (i.e. U_{M}<U₃) the current state Z=c (“object in the vicinity”) is switched to the Z=b state (“no object detected”). A user is thus informed again that he has reached an area without enclosed objects.

In the case of a dynamic threshold U_{M}, the second predetermined percentage P₂ which serves as condition for switching from a Z=c state (“object in the vicinity”) to a Z=a state (“object detected”) is selected to have a smaller magnitude than the first predetermined percentage P₁ which serves as condition for switching from a Z=a state to a Z=c state. Since the percentage is smaller for exceeding a minimum value than for staying below a maximum value, an object can be localized even more accurately when it is traversed several times than when it is traversed once. This relationship is shown again in FIG. 4 by means of a single object 12 and will be explained again in the text which follows.

If the measuring device is moved in the direction of arrow 32 over the surface 26 of a wall 34, starting from the starting position X₀, the measurement signal U_{M} rises initially. If during this process the measurement signal U_{M} currently measured exceeds a threshold value U_{S}, a state signal Z is generated from the measurement signal which represents the Z₁=c state (“object in the vicinity”). A user is thus informed that there must be an enclosed object 12 in the vicinity. If the measuring device is moved further in the direction of arrow 32, the measurement signal U_{M} currently measured passes the position X_{Max} through a maximum value, the position X_{Max} of which could be identified with the accurate position of the enclosed object 12, for example by means of an additional bar chart display. If the measuring device is moved further beyond the position X_{Max} in the direction of the arrow 32 over the surface 26 of the wall 34, the measurement signal U_{M} currently measured drops again compared with the maximum value U_{Max} without a change in the state Z₁=c initially being produced. If the measurement signal U_{M} currently measured drops by a predetermined percentage P₁ which is about 15% in the exemplary embodiment of FIG. 4, compared with the value of the peak U_{Max}, a state signal Z₁=c (“object in the vicinity”) is then generated from the measurement signal U_{M}.

If the user thereupon changes the direction of travel of the measuring device at a point X₁ from the direction of arrow 32 to the direction of arrow 33 in order to identify the precise position of the object, the value U_{U} last measured (reversing point) of the measurement signal U_{M} serves as measured local minimum value. If the measuring device is now moved towards the enclosed object 12 in the direction of arrow 33, the Z₂=c state is retained, according to the invention, until the currently measured measurement value of the measurement signal U_{M} exceeds a percentage P₂ of the minimum value U_{U} measured last. In the exemplary embodiment according to FIG. 4, a 10% rise compared with the minimum value U_{U} last measured is necessary, i.e. P₂=10%, for updating the condition of switching from Z₂=c (“object in the vicinity”) to the Z₂=a state (“object detected”). In the exemplary embodiment of FIG. 4, this signal level is reached at a position X₂. I.e. when the measuring device is moved back in the direction of arrow 33, the lateral area about which the method according to the invention transmits the information and the signal Z=a (“object detected”) to a user is defined for the first time.

If the measuring device is then moved further in the direction of arrow 33, the measurement signal U_{M} currently measured passes again through a maximum value at position X_{Max} and then drops continuously during the further travel in the direction of arrow 33. If the value of the measurement signal U_{M} currently measured drops below a predetermined fixed percentage P₁ of the maximum value U_{Max} (this is the case at location X₃ in the exemplary embodiment of FIG. 4), the signal Z is corrected again to a Z₂=c state from the state Z₂=a (“object detected”). In the exemplary embodiment of FIG. 4, the percentage P₁ is, for example, 15%, i.e. P₁=15%, but can assume any value, in principle. It is advantageous to pay attention to the fact that the percentage P₁ is selected to be greater than the percentage P₂.

As can be seen in FIG. 4, the area over which the enclosed object 12 is localized when traveling back in the direction of arrow 33 (i.e. state Z₂=a) is distinctly restricted compared with the original area Z₁=c. If a user again changes the direction of travel at position X₃, at which the system changed from the “object detected” state (Z₂=a) to the “object in the vicinity” state (Z₂=c) and the measuring device now again travels once more in the direction of arrow 32 over the object 12 to be localized, the area over X_{Max} is again restricted compared with the area Z₂=a.

Using a dynamic threshold U_{U}, a user is thus enabled by means of the method according to the invention to localize the precise position of an enclosed object (position X_{Max} in FIG. 4) without knowing the exact variation of the measurement signal U_{M}. It is due to the signal according to the invention relating to the state of the system (Z=a) corresponding to “object detected” or (Z=c) “object in the vicinity” alone and especially due to the different magnitude of the switching conditions P₁ and P₂ for changing the respective state that it is possible to localize an enclosed object with distinctly increased accuracy. The Z=a “object detected” state thus corresponds to the actual information “object localized”, instead.

Thus, for example, a measuring device can provide only the output of the derived signal Z and still enable enclosed objects to be localized accurately. An intensity or amplitude information for the measurement signal, as can be implemented, for example, with continuously operating analog pointer devices or digital bar displays, can be advantageously omitted in the measuring device according to the invention. Naturally, it can be provided also in measuring devices according to the invention that both the signal Z and the measurement signal U_{M} is output.

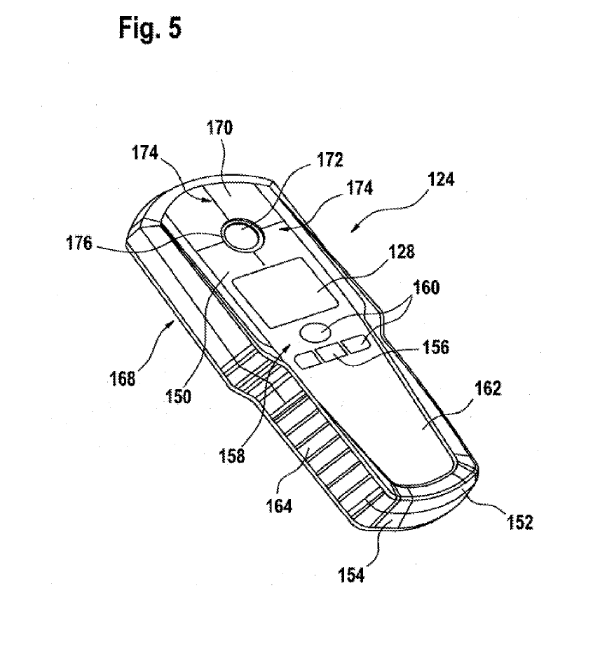

FIG. 5 shows a possible exemplary embodiment of a measuring device according to the invention, especially a hand-held positioning device according to the method according to the invention in a perspective overview representation.

The measuring device 124 according to the invention has a housing 150 which is formed from a upper and a lower half shell 152 and 154, respectively. In the interior of the housing, at least one sensor having a receive wire loop system, for example a coil arrangement, is provided. Further sensors such as, for example, inductive or capacitive sensors can also be integrated in the measuring device 124. In other exemplary embodiments, however, the measuring device 124 could also be a radar positioning device, for example a UWB radar or also a single frequency radar.

The interior of the measuring device 124 has corresponding signal generating and evaluating electronics and a power supply, for example by batteries or accumulators. Thus, the system could be operated, for example, by means of a Li-ion battery pack, especially a 10.8-V pack. The measuring device according to FIG. 5 additionally has a display 128 for outputting an output signal correlated with the measurement signal. Via the display 128 or a segmented bar display or also a graphical display using an LCD, it is possible to display the intensity of the detected measurement signal U_{M}.

Furthermore, the measuring device according to the invention has an operating panel 158 with a row of operating elements 160 which enable the device to be switched on or off, respectively, and possibly starting a measuring process or a calibration process. An operating element 156 can enable a user, for example, to vary the frequency of the measurement signal. In addition, it can also be provided that this variation of the measuring frequency is performed automatically by the device and, in particular, is not accessible to a user.

In the area below the operating panel 158, the measuring device according to FIG. 5 has an area 162 which is designed in its shape and material configuration as a handle 164 for carrying the measuring device according to the invention. By means of this handle 164, the measuring device is conducted with its underside, facing away from the observer of FIG. 5, over a surface of an object or a medium to be examined, such as, for example, the surface 26 of a wall 10 according to the diagrammatic representation in FIG. 3.

On the side 170 of the measuring device 124 opposite the handle 164, it has an opening 172 penetrating the housing. The opening 172 is arranged concentrically at least with the receive wire loop system 134 of the sensor. In this manner, the location of the opening 172 in the measuring device corresponds to the center of the positioning sensor so that the user of such a device is thus also simultaneously indicated the precise position of any object detected. At the same time, a user can mark by means of this opening the precise position of an object, once localized, on the underground such as, for example, the wall surface examined by passing a marking means through the opening. In addition, the measuring device additionally has on its top marking lines 174 via which the precise center of the opening 172, and thus the position of an enclosed object, can be localized by the user.

The opening 172 is limited by a partially transparent sleeve 176 into which the light of different light-emitting diodes can be fed. If the measuring device detects a measurement signal U_{M} from which a state signal Z=a or Z=b or Z=c is generated in accordance with the method described, the sleeve can be illuminated, for example, in red in order to inform a user that an object has been localized at the location of the opening 172 (Z=a) and he, therefore, should refrain from drilling at this point, for example. If by means of the method according to the invention a signal according to the Z=b state (“no object detected”) is generated, green light can be fed into the sleeve, for example, in order to signal to a user that no object has been localized and he could safely perform, for example, drilling in the area of the opening 172 of the measuring device. If a signal according to the Z=c state (“object in the vicinity”) is generated by means of the method according to the invention, amber light can be fed into the sleeve, for example, in order to signal to a user that, although no object has been localized directly at the current position, he could expect an object in the vicinity and, therefore, increased caution is advisable. To provide the color coding of the three states Z=a, b, c, three different light sources, for example colored diodes can be used, or a mixed signal can also be generated in each case. As well, three concentric sleeves could be used instead of one sleeve.

It is also possible to provide the measuring device without such an opening and to provide only one or more color-producing light-emitting means in or at the housing. In such an alternative embodiment of the measuring device according to the invention, the Z state can also be reproduced directly via output means such as, for example, light-emitting diodes which are arranged visibly in or at the housing of the measuring device.

Further options for transmitting the respective state of the detection system to a user are presented in detail in the advantages of the invention and will not be repeated again at this point.

The method according to the invention or a measuring device operating in accordance with this method is not restricted to the exemplary embodiments shown in the figures.

In particular, the method according to the invention is not restricted to the use of only one transmit coil or one receive wire loop system. Multiple systems are also possible. Such a positioning device could also have, for example, a compensation sensor. Such a sensor comprises, for example, three coils, a first transmit coil being connected to a first transmitter, and a possibly present second transmit coil being connected to a second transmitter and a receive wire loop system serving as receive coil being connected to a receiver. The two transmit coils are fed by their transmitters with alternating currents of a frequency f_{M} and oppositely placed phase. In this arrangement, the first transmit coil induces in the receive coil a flux which is opposite to the flux induced in the receive coil by the second transmit coil. Both fluxes induced in the receive coil thus cancel one another so that the receiver does not detect any receive signal in the receive coil if there is no external metallic object in the vicinity of such a coil arrangement. The flux φ excited in the receive coil by the individual transmit coils depends on various values such as, for example, the number of turns and the geometry of the coils and on amplitudes of the currents fed into the two transmit coils and their mutual phase angle. These values must lastly be optimized in such detectors so that in the case of an absence of a metallic object, the least possible flux φ is excited in the receive coil.

As an alternative, it is also possible to use only one transmit coil and to position the receive system of turns in space in such a manner that in the case of an absence of metallic objects, no voltage is induced in the receive wire structures.

In other exemplary embodiments, however, the measuring device according to the invention could also be a capacitive positioning device or also a radar positioning device, for example a UWB radar or also a single frequency radar.

The combination of a number of sensors in one measuring device is also possible.

In addition, it is also possible and advantageous to integrate a sensor according to the method according to the invention directly or as an attachment in a machine tool or a drilling tool in order to enable a user to work safely with this machine.

1. A method for localizing objects enclosed in a medium with a detection system, comprising:
generating a measurement signal correlated with an enclosed object;
generating a state signal, from the measurement signal, the state signal configured transmission to a user; and
enabling at least a distinction to be made between a first state, at least one second state, and a third state,
wherein the first state corresponds to an object detected state,
wherein the at least one second state corresponds to a no object detected state, and
wherein the third state corresponds to an object in the vicinity state.

2. The method as claimed in claim 1, wherein the state signal includes precisely three discrete states.

3. The method as claimed in claim 1, further comprising:
changing from the first state to the third state if a magnitude of the measurement signal currently measured stays below a previously measured local maximum value of the measurement signal by a predetermined first percentage.

4. The method as claimed in claim 1, further comprising:
changing from the third state to the at least one second state if a magnitude of the measurement signal currently measured stays below a predeterminable first threshold value.

5. The method as claimed in claim 4, wherein the predeterminable first threshold value is equal to a noise signal level of the detection system.

6. The method as claimed in claim 1, further comprising:
changing from the at least one second state to the third state if a magnitude of the measurement signal currently measured exceeds a predeterminable first threshold value,
wherein the predeterminable first threshold value is a threshold value of a noise signal level of the detection system.

7. The method as claimed in claim 4, further comprising:
changing from the third state to the first state if the magnitude of the measurement signal currently measured exceeds a predeterminable second threshold value.

8. The method as claimed in claim 3, further comprising:
changing from the third state to the first state if the magnitude of the measurement signal currently measured exceeds the previously measured local minimum value of the measurement signal by a predetermined second percentage.

9. The method as claimed in claim 8, wherein the predetermined second percentage is smaller than the predetermined first percentage.

10. The method as claimed in claim 1, further comprising:
transmitting at least one of the first state, the at least one second state, and the third state to a user by means of a color code including, different colors.

11. The method as claimed in claim 10, further comprising:
transmitting at least one of the first state, the at least one second state, and the third state to a user by means of three different colors.

12. The method as claimed in claim 10, wherein an amber hue is allocated to the third state.

13. The method as claimed in claim 1, further comprising:
measuring the measurement signal as a function of a lateral displacement of a sensor of the detection system.

14. A measuring device, comprising:
an output means which configured to allow a first state, at least one second state, and a third state to be reproduced,
wherein the measuring device is configured to carry out a method for localizing objects enclosed in a medium,
wherein the method includes (i) generating a measurement signal correlated with an enclosed object, (ii) generating a state signal, from the measurement signal, the state signal configured for transmission to a user, and (iii) enabling at least a distinction to be made between the first state, the at least one second state, and the third state,
wherein the first state corresponds to an object detected state,
wherein the at least one second state corresponds to a no object detected state, and
wherein the third state corresponds to an object in the vicinity state.

15. The measuring device as claimed in claim 14, wherein the first state, the at least one second state, and the third state Z is are reproduced visually.

16. The measuring device as claimed in claim 15, wherein the first state, the at least one second state, and the third state are reproduced by means of three different colors.

17. The measuring device as claimed in claim 14, further comprising:
at least one sensor including at least one receive wire loop system.

18. The measuring device as claimed in claim 14, further comprising:
at least one sensor including at least one UWB antenna element.
